(19) United States
(12) Patent Application Publication
(10) Pub. No.: US 2003/0047529 A1
(43) Pub. Date: Mar. 13, 2003

(54) Loading and unloading plant in a sea or river port

(76) Inventors: Mathias Dobner, Rommerskirchen (DE); Hermann Franzen, Monchengladbach (DE); Joachim Kroll, Juchen (DE); Gerlinde Pohlmann, Aachen (DE)

Correspondence Address: COHEN, PONTANI, LIEBERMAN & PAVANE, 551 FIFTH AVENUE, SUITE 1210, NEW YORK, NY, 10176, US

(21) Appl. No.: 10/181,607

(22) PCT Filed: Jan. 16, 2001
(86) PCT No.: PCT/DE01/00234

(51) Int. Cl. B66C 23/06

(52) U.S. Cl. 212/232

(57) ABSTRACT

The invention relates to a loading and unloading plant in a sea or river port, in particular for ISO containers, comprising a container storage facility which is located along a quay and consists of individual line-type storage modules and at least one loading device for handling loads to and from a vessel on the quay. In this case, the loading plant for loading and unloading loads comprises at least one mobile harbor crane (5), whose load jib extends into the area of at least one transfer point (6) which is provided within a container storage facility (7) consisting of a number of storage modules (9, 9.1, 9.2) with a number of container rows that depends on the width of the module, and forms an interface between the mobile harbor crane (5) and the storage modules (9, 9.1, 9.2) of the container storage facility (7).

### DESCRIPTION

The invention relates to a loading and unloading plant in a sea or river port, in particular for ISO containers, comprising a container storage facility which is located along a quay and consists of individual line-type storage modules and at least one loading device for handling loads to and from a vessel on the quay.

For loading and unloading ISO containers between various types of transport means, for example ship, rail or HGV, loading plants are used which have to ensure the loading and unloading of piece goods with the fewest possible faults at high throughput rates. The central constituent of a container loading and unloading plant is generally a container storage facility, which decouples the streams of piece goods and therefore ensures operation of the various types of transport means which meets the demand. The operation of the various types of transport means which matches the occurrence and demand requires an optimized design for the overall loading and unloading plant.

DE 44 39 74 C1 discloses a generic loading and unloading plant for ship, rail and HGV transport. The central component of this loading and unloading plant is a container storage facility which consists of a plurality of individual line-type storage modules, in which a stacking crane is used in each case for putting goods into store and removing them. Between ship and storage facility, container bridges operate, which are connected to the storage facility via transport means that move over roadways. In addition, loading and unloading to ground-based transport means, such as HGV and rail, is carried out. While the loading and unloading process on the sea side between ship and storage facility is automated to the greatest extent and can therefore be configured to be quick, in order to match this, that is to say in order to ensure an overall balanced flow of piece goods, the loading and unloading between the storage facility and the land-side ground-based transport means can be provided only with increased effort from the loading plant used here. One reason for this is that this loading and unloading process can be automated only to a limited extent, because of the manually guided ground-based transport means, relevant safety guidelines having to be observed and conflicting with the quickest possible processing of the loading and unloading.

Fully automatic container terminals, which interact with driverless transport vehicles (AGVs) for horizontal transport are known, but these are always very large plants in large sea ports, which are only economic to operate when an extremely high throughput of piece goods is achieved. For reasons of economy, smaller terminals have therefore only been partly automated hitherto, although there is the desire here too to save costs or to increase throughput by means of automated transport sequences.

On the basis of a loading and unloading plant described above, the object of the present invention is to provide an extremely compact container terminal which also puts the operator of small loading and unloading plants in a position to automate his container storage facility. At the same time, the loading and unloading costs are to be reduced and the investment and maintenance costs are to be kept low.

In order to achieve the object, the invention proposes a loading plant for loading and unloading loads which comprises at least one mobile harbor crane whose load jib extends into the area of at least one transfer point which is provided within a container storage facility consisting of a number of storage modules with a number of container rows that depends on the width of the module, and forms an interface between the mobile harbor crane and the storage modules of the container storage facility.

In this novel loading and unloading plant, the horizontal transport between ship and container storage facility, which is provided in conventional automated plants and was conventionally provided by manual or automated transport vehicles, is dispensed with. Omitting these vehicles and therefore the roadways which are no longer required on the quay between container storage facility and ship permits the use of mobile harbor cranes instead of complicated widely overhanging container bridges. It is therefore possible for the investment costs to be reduced by about 40% as compared with plants operating with container bridges. The mobile harbor cranes can be moved easily and can also be used universally in other regions of the quay.

The jibs of the harbor cranes, which can be pivoted between the ship to be unloaded and the container storage facility, pick up the container and set it down at the transfer point which is associated with the container storage facility and which, according to the invention, is provided with centering means and guides for the containers for better positioning.

According to a further feature of the invention, provision is made for each of a number of storage modules of the container storage facility to run transversely with respect to the quay and preferably to be nine containers wide and three to four containers high.

According to the invention, for each storage module, at least one stacking crane monitored and controlled by a higher-order storage logic unit performs the acceptance, the horizontal transport and the stacking of the containers. The stacking crane grips the containers set down by the mobile harbor crane at the respective transfer point in the container storage facility, which forms the interface between the mobile harbor crane and the stacking crane.

The stacking crane itself is constructed conventionally as an upright bridge crane with a trolley and, in a known way, in each case covers one storage module of the container storage facility.

In a development of the invention, provision is made to subdivide the container storage facility in accordance with the storage characteristics into at least two areas, preferably parallel to the quay and centrally in relation to the container storage facility. The two areas can, for example, be an import and an export area, and the stacking cranes preferably travel over both areas.

Furthermore, it is proposed that at least two cross transporters which can be moved on rail tracks running transversely to the individual storage modules in different horizontal planes and act independently of each other link the storage modules to one another and perform horizontal transport of the containers between the two storage areas, the cross transporters being monitored and controlled by the higher-order storage logic unit. In this way, the fully automatic stacking cranes operating in the storage modules are able to transport the containers from the transfer points either directly into the associated storage modules or to one of these two cross transporters. The cross transporters control either another storage module or one of the two removal points which, according to the invention, are formed by the rail tracks of the cross transporters being extended, on at least one longitudinal side of the storage facility, for inputting and removing containers beyond the modules located on the outside, as far as the area of a preferably multi-lane access roadway.

If the output and input of containers from and to HGVs is carried out, provision is made to form an unloading area for HGVs underneath the rail track extension, it being possible for this area to be operated by a bridge crane set up on stands on a short rail track.

According to the invention, the HGV loading crane is operated under remote radio control by means of the checker or operator, as he is known, from the gate office, which is arranged in an optimum viewing position in the secured area between access and exit roadways.

According to a further feature of the invention, provision is made for a reach stacker and other special loading and unloading devices to have access to empty containers at one end of the rail track of the two cross transporters, beside the preferably two-lane exit roadway, and to incorporate the adjacent empty container storage facility into the container terminal. In this way, it becomes very simply possible to put the empty containers into and out of the system, specifically at the point at which the loading and unloading of the HGVs is carried out, but also on that side of the container storage facility which is opposite thereto at the other end of the rail track.

According to a further feature of the invention, in order to put in and remove the containers envisaged for rail loading and unloading and for their horizontal transport between storage facility and rail, reach stackers are used, which also operate the provision area on the rail side.

The advantages of the invention can be seen in particular in the fact that the loading and unloading plant according to the invention also puts the operators of small loading and unloading terminals in a position to automate the container storage facility. The costs for investments and maintenance can be set 30 to 40% lower as compared with conventional container storage facilities operated with straddle carriers or reach stackers. The reduced loading and unloading costs (DM per container), in conjunction with other advantages of an automated container storage facility, such as short waiting times, secure loading an d unloading, 100% access accuracy, move the operators of compact terminals in this service area into a strong, competitive position. Since easily movable mobile harbor cranes are used as the loading and unloading device, and can also operate universally in other crane areas, only about 60% of the investment costs of a corresponding container bridge are needed.

An exemplary embodiment of the invention is illustrated in the drawing and will be described below. In the drawing:

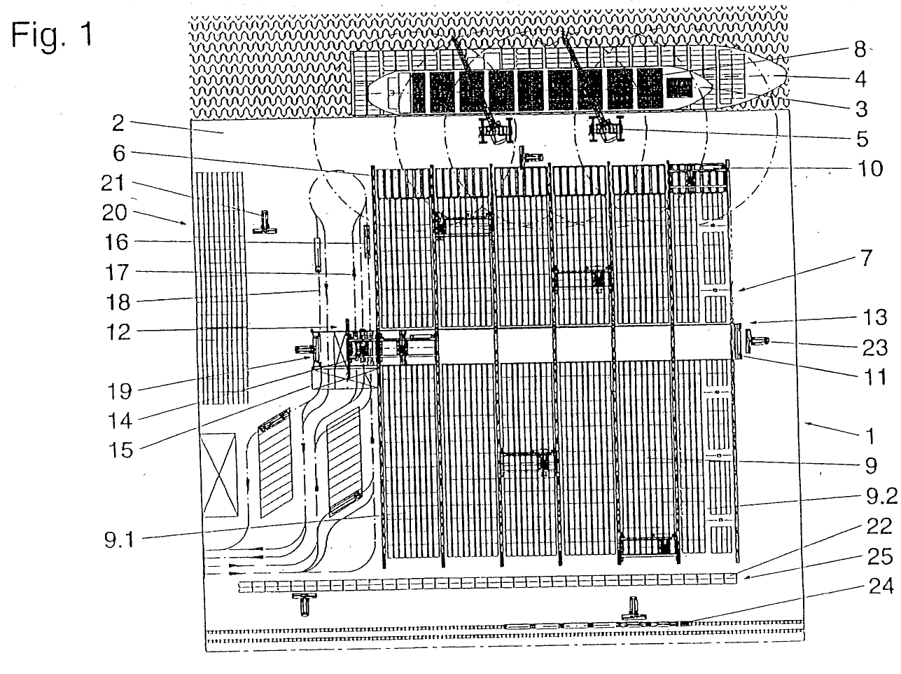

FIG. 1 shows the plan view of the container terminal according to the invention.

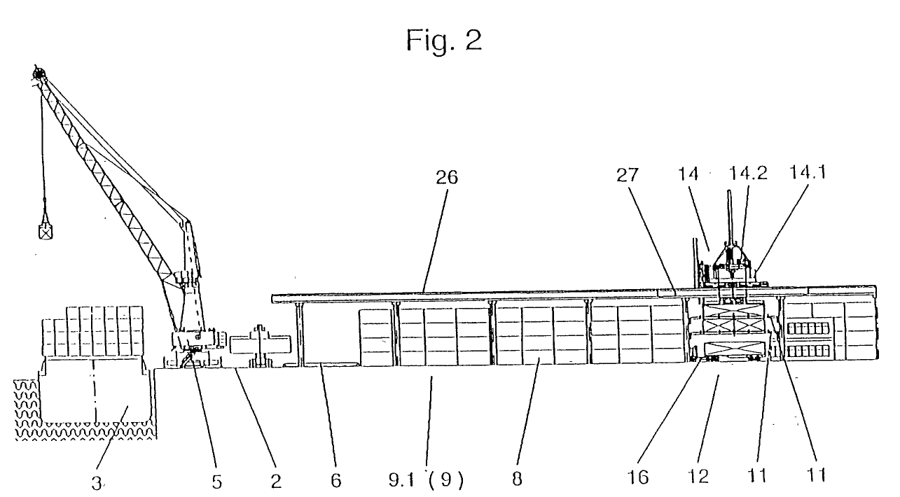

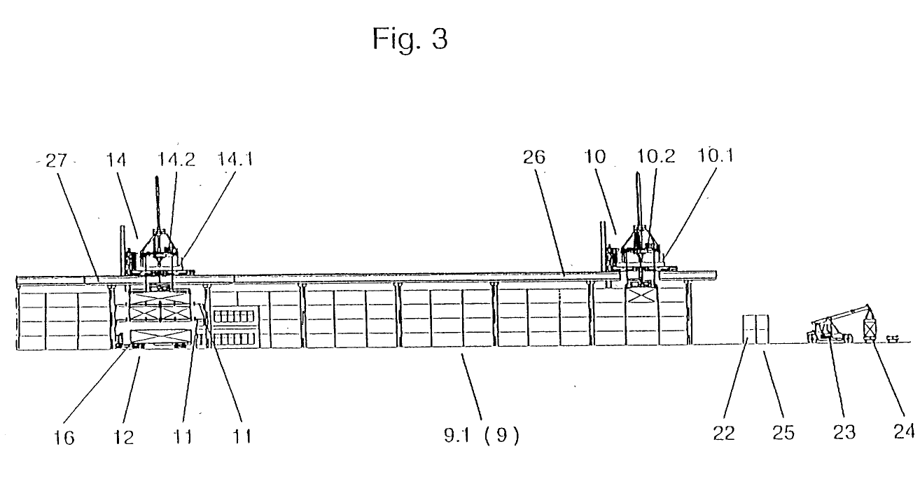

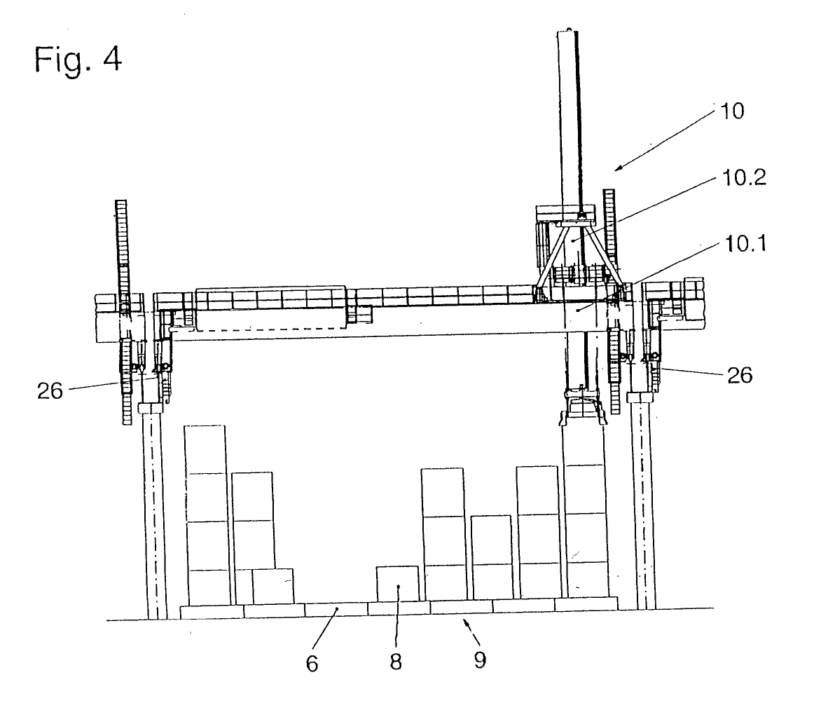

FIGS. 2 and 3 show side views of the terminal according to FIG. 1, FIG. 4 shows a detail view of the terminal from the water side in the direction of the storage facility, and

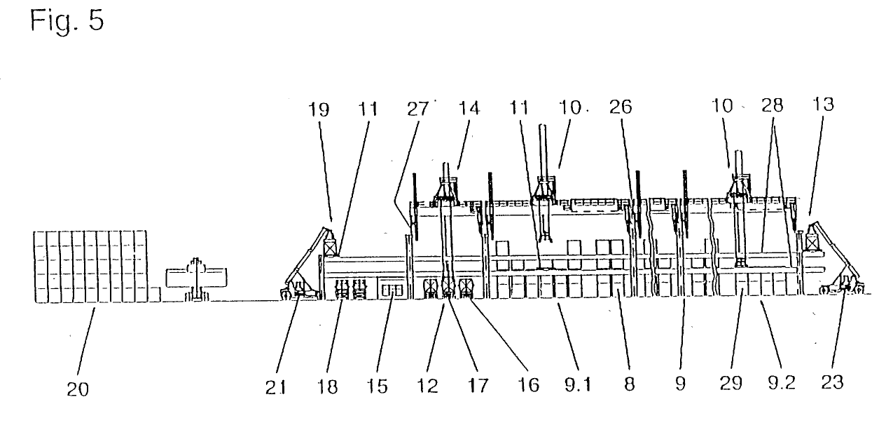

FIG. 5 shows a section through the terminal in the area of the HGV checkout facility.

In FIG. 1, in a plan view of the compact container terminal 1 according to the invention, a container ship 3 or 4 lying on the quay 2 can be seen. In order to load and unload the container ship or 4, two mobile harbor cranes 5 are provided, which can move on the quay 2. On the long side of the container storage facility, facing the quay, there are preferably six transfer points 6, which form the interface to the container storage facility 7. Monitored by an appropriate loading and storage logic unit, the containers 8 are in each case set down on one of the transfer points, each transfer point being associated with one of the storage modules 9, 9.1 or 9.2.

The fully automatic stacking cranes 10 operating in the storage modules 9, 9.1 or 9.2 transport the containers 8 from the transfer points 6 either directly into the associated storage modules or to one of the two cross transporters 11. The cross transporters 11 select a different storage module or one of the two removal points, namely the removal point for the HGV checkout facility 12 or the removal point for the rail checkout facility 13.

The loading or unloading of the containers to or from the HGV checkout facility 12 is performed by the HGV loading crane 14, which is controlled manually from the gate office 15. The HGV loading crane 14 serves the HGVs 6, which are led in on the three-lane access roadway 17 of the HGV checkout facility 12 and are led out on the two-lane exit roadway 18. Via the removal point for the HGV checkout facility 12, the empty container storage facility 20 is also integrated in the compact container terminal 1 via the removal point for the empty containers 19. The operation of the empty container storage facility is carried out manually by means of reach stackers 21 or other special stacking devices for the empty containers. The containers 22 which are intended for rail loading are transported manually by means of reach stackers 23 from the removal point for the rail checkout facility 13 either directly to the rail 24 or to the provision area 25.

FIGS. 2 and 3 in each case show one half of the side view of the container terminal 1 according to the invention. In FIG. 2, the container ship 3 lying on a quay 2 can be seen on the left-hand side, as well as the mobile harbor crane 5 during the unloading operation. It is also possible to see the transfer point 6, the containers 8, the storage module 9.1, the stacking crane 10, the two cross transporters 11, the HGV loading crane 14 and an HGV 16.

The stacking crane 10 comprises the bridge 10.1 and the trolley 10.2. It moves on a crane track 26 which is set up on stands and extends over the entire length of the storage module 9.1. The loading crane 14 comprises the bridge 14.1 and the trolley 14.2. It moves on a short crane track 27 which is set up on stands and extends only in the area of the HGV checkout facility 12.

The containers 22 which are intended for rail loading, as can be seen in the right-hand half of FIG. 3, are transported manually by means of reach stackers 23 from the removal point for the rail checkout facility either directly to the rail 24 or into the provision area 25.

FIG. 4 shows a detail view from the water side in the direction of the storage facility. The illustration shows, as a detail of the container storage facility, a front view of a storage module 9 with its transfer points 6, the containers 8, the stacking crane 10, comprising the bridge 10.1 and the trolley 10.2, at the crane track 26 set up on stands.

Drawing FIG. 5 shows a section through the container storage facility in the area of the HGV checkout facility 12. It is possible to see in particular the outer storage modules 9.1 and 9.2. The storage module 9.1 adjoins the area of the HGV checkout facility 12. It is possible to see the container 8, the stacking crane 10, the cross transporter 11, the HGV loading crane 14, the gate office 15, the HGVs 16, the three-lane access roadway 17, the two-lane exit roadway 18, the removal point for the empty containers 19, the empty container storage facility 20 and the reach stacker 21 for the empty containers.

The HGV loading crane 14 moves on the short crane track 27 set up on stands. The two cross transporters 11 guided on the rail tracks 28 perform the horizontal transport of the container 8. The opposite long-side limit of the container storage facility is formed by the storage module 9.2. In this storage module, half of the spaces are reserved for chilled containers 29. Furthermore, it is possible to see the removal point for the rail checkout facility 13 and the reach stackers 23 for rail loading.

An unloading operation of a container ship 3 or 4 could proceed as follows:

the mobile harbor crane 5 picks up a container from the container ship 3 and, after the jib has been pivoted, sets it down on one of the transfer points 6 of the container storage facilities according to the invention. One of the automatic stacking cranes 10 picks up the container and transports it either to one of the storage modules located behind or to one of the two cross transporters 11. The cross transporter 11 permits the container to be moved into one of the other storage modules 9, 9.1 and 9.2 or permits the container to be transported into the area of the HGV checkout facility 12 or the rail checkout facility 13. In the area of the HGV checkout facility 12, the container 8 is picked up by the HGV loading crane 14, which moves on the crane wall 27 set up on stands. In the area of the HGV checkout facility 12 underneath the HGV loading crane 14, three lanes 17 for the HGVs 16 are provided; the containers are set down on the HGVs. The HGVs 16 are guided in a turning loop on to the two-lane exit roadway, via which they leave the container terminal. Empty containers 19 are transported between the empty container storage facility 20 and the cross transporter 11 with the aid of the reach stacker 21. Likewise, by using reach stackers 23, containers 8 at the removal points 13 for the rail checkout facility are picked up on the side of the container storage facility opposite to that of the HGV checkout facility.

1. A loading and unloading plant in a sea or river port, in particular for ISO containers, comprising a container storage facility which is located along a quay and consists of individual line-type storage modules and at least one loading device for handling loads to and from a vessel on the quay, characterized in that the loading plant for the loading and unloading consists of at least one mobile harbor crane (5), whose load jib extends into the area of at least one transfer point (6) which is provided within a container storage facility (7) consisting of a number of storage modules (9, 9.1, 9.2) with a number of container rows that depends on the width of the module and forms an interface between the mobile harbor crane (5) and the storage modules (9, 9.1, 9.2) of the container storage facility (7).

2. The loading and unloading plant as claimed in claim 1, characterized in that each transfer point (6) is provided with centering means and guides for the containers (8).

3. The loading and unloading plant as claimed in claim 1 and 2, characterized in that each storage module (9, 9.1, 9.2) of the container storage facility (7) extend s transversely with respect to the quay (2) and is preferably nine containers (8) wide and three to four containers (8) high.

4. The loading and unloading plant as claimed in claims 1 to 3, characterized in that for each storage module (9, 9.1, 9.2), at least one stacking crane (10) that is monitored and controlled by a higher-order storage logic unit performs the acceptance, the horizontal transport and the stacking of the containers (8).

5. The loading and unloading plant as claimed in claim 4, characterized in that the stacking crane (10) is constructed as a bridge crane (10.1) set up on stands and having a trolley (10.2).

6. The loading and unloading plant as claimed in claims 1 to 5, characterized in that the container storage facility (7) is subdivided into at least two areas, preferably parallel to the quay (2) and centrally in relation to the container storage facility (7), in accordance with the storage characteristics.

7. The loading and unloading plant as claimed in claims 1 to 6, characterized in that two cross transporters (11) which can be moved on rail tracks (28) but run transversely with respect to the individual storage modules (9, 9.1, 9.2) in different horizontal planes and act independently of each other link the storage modules (9, 9.1, 9.2) to each other and perform the horizontal transport of the containers (8) between the two storage areas, the cross transporters (11) being monitored and controlled by the higher-order storage logic unit.

8. The loading and unloading plant as claimed in claims 1 to 7, characterized in that the rail tracks (28) of the cross transporters (11) on at least one long side of the storage facility are extended beyond the outer modules (9.1, 9.2) and into the area of a preferably multi-lane access roadway (17) in order to put containers (8) in and out.

9. The loading and unloading plant as claimed in claim 8, characterized in that an unloading area for HGVs (12) is formed underneath the rail track extension, it being possible for said area to be served by an HGV loading crane (14) set up on stands on a short rail track (27).

10. The loading and unloading plant as claimed in claims 8 and 9, characterized in that the operation of the HGV loading crane (14) is carried out under remote radio control by the checker or operator of the gate office (15), which is arranged in an optimum viewing position in the secured area between access (17) and exit roadway (18).

11. The loading and unloading plant as claimed in claims 1 to 10, characterized in that at one end of the rail track (28) of the two cross transporters (11), beside the preferably two-lane exit roadway (18), reach stackers (21) or other special loading and unloading devices have access to empty containers and incorporate the adjacent empty container storage facility (20) in the container terminal (1).

12. The loading and unloading plant as claimed in claim 11, characterized in that the empty containers are put in and out (19) at at least one end of the rail track of the two cross transporters (11).

13. The loading and unloading plant as claimed in claims 1 to 12, characterized in that in order to put the containers (22) provided for rail loading in and out, and their horizontal transport between container storage facility (7) and rail (24), reach stackers (23 ) are used, which also serve the provision area (25) on the rail side.
